(19) United States
(12) Patent Application Publication
(10) Pub. No.: US 2012/0239457 A1
(43) Pub. Date: Sep. 20, 2012

(54) SYSTEMS AND METHODS FOR GENERATING AND UTILIZING USER PROFILES BASED ON PRIOR USER RESPONSES

(76) Inventor: Paul Janowitz, Austin, TX (US)

(21) Appl. No.: 13/452,354

(22) Filed: Apr. 20, 2012

Related U.S. Application Data
(63) Continuation of application No. 13/398,690, filed on Feb. 16, 2012, now abandoned.
(60) Provisional application No. 61/454,304, filed on Mar. 18, 2011.

(51) Int. Cl. G06Q 30/02

(52) U.S. Cl. 705/7.32

(57) ABSTRACT

A system and method for generating a user's profile from their own user-generated content to transform community driven ideas into a company managed idea community and market research platform. The profile associated with the user is updated to provide for persistent unique profile sections based on content generated, associated activity, and end-user domains visited that may be managed by the user from a single portal. The system also provides a method for taking community content and transforming the content into selection criteria for market research. Product researcher administrators may view these community generated ideas to screen for users based on actual behavior. User-generated content may also be used as triggers to invite users to participate in surveys or discussions based upon their activity within the platform.

### CROSS-REFERENCE TO RELATED APPLICATIONS

This application claims priority to U.S. Provisional Patent Application Ser. No. 61/454,304 filed Mar. 18, 2011, which is hereby incorporated by reference in its entirety.

This application is also a continuation of U.S. patent application Ser. No. 13/398,690, filed Feb. 16, 2012, which is hereby incorporated by reference in its entirety.

### FIELD

This disclosure relates in general to the field of surveys, focus groups, and blogs and more particularly to a method and system for generating and utilizing user profiles that are based on the user's prior responses within a research platform.

### DESCRIPTION OF THE RELATED ART

Product developers and researchers have always sought the feedback of their customers and end users for purposes of identifying defects and improving products.

Traditionally, these product developers have engaged in activities such as market studies or focus groups to obtain information about their perceptions or attitudes about a certain product or action. However, this requires labor intensive gathering of information regarding age, gender, employment situation, and other data to determine qualifications to participate in different studies. This type of preliminary survey is inefficient and does not guarantee that the researcher will be able to find appropriate members for their specific focus group. Additionally, there is the very real possibility that the participant is not answering truthfully in order to gain access to the research or focus group.

Market research often fails because it is not actionable and not directly tied to improvements and real stakeholders. Research today takes too long, costs too much and takes an army to manage, interpret and present findings.

Recently, product developers have gone to the Internet to more easily connect with their customers and obtain data from reviews to enhance their product quality and development processes. However, these methods are one-sided exchanges of information, and the researcher is unable to easily communicate with the reviewer to dig deeper for more information.

Online research firms have tried to bridge this gap by acting as an intermediary between product developers and the customer. This may come in many forms, such as software for feedback collection, surveys, polls, research panel creation, or research panel management. However, these approaches often are too complex and do not solicit the right answers from the right people. Another concern that is only heightened because of the Internet's anonymity is the concern over false responses.

The above-mentioned approaches have shortcomings. More particularly, other solutions are not easy for the customer or the product developer to communicate with each other. Pertinent data may be lost in complex customer-service solutions or buried within threads of online discussion forums. Additionally, these approaches are often reactive, with the product developer often finding out about issues only after they have become a problem.

The above-mentioned approaches may be impractical models that do not allow for the product developer to engage in meaningful communication with their customers regarding past or future products in an efficient and economical way nor do they permit sufficient vetting of participants before their entry into the focus/research group. A need exists, therefore, for improved customer-service research solutions without shortcomings.

### SUMMARY

The following disclosure presents concepts for improving utility of product development and customer-service research solutions. The disclosed subject matter significantly improves upon prior art aimed at providing a forum for customers to connect with product developers and give feedback on what changes may be made to improve products. It is an object of the present disclosure to permit the best discussions and customer contributors to be readily identifiable so that the product developer gets the most value through interactions within public discussions and more private focus groups.

The present disclosure teaches an online community for purposes of facilitating communication between product or service developers and their customers, where each customer is identifiable via a profile for each user of the community. One aspect of the disclosed subject matter is the ability for users to view discussion threads organized according to various predetermined metrics.

Another aspect of the disclosed subject matter is the flexibility by which user ideas or concerns may be communicated to the community and to product developers.

Yet another aspect of the disclosed subject matter is the user profile based upon user-generated content.

Another aspect of the disclosed subject matter is the ability of users, product developers, and administrators to directly invite others to create private focus groups.

Another aspect of the disclosed subject matter is automatic triggering of research actions based upon predetermined trigger points.

Yet another aspect of the disclosed subject matter is the integration of the community with other online networks.

These and other aspects of the disclosed subject matter, as well as additional novel features, will be apparent from the description provided herein. The intent of this summary is not to be a comprehensive description of the claimed subject matter, but rather to provide a short overview of some of the subject matter's functionality. Other systems, methods, features and advantages here provided will become apparent to one with skill in the art upon examination of the following FIGUREs and detailed description. It is intended that all such additional systems, methods, features and advantages that are included within this description, be within the scope of the claims.

### BRIEF DESCRIPTIONS OF THE DRAWINGS

The novel features believed characteristic of the presently disclosed subject matter will be set forth in the accompanying claims and any filed later. The presently disclosed subject matter itself, however, as well as a preferred mode of use, further objectives, and advantages thereof, will best be understood by reference to the following detailed description of an illustrative embodiment when read in conjunction with the accompanying drawings, wherein:

FIG. 1 illustrates the flow of ideas within the present disclosure's research platform.

FIG. 2 displays a flow of how ideas flow to create research studies through the present disclosure's platform (screenshot).

FIG. 3 portrays an exemplary embodiment of the present disclosure's research platform in one application (screenshot).

FIG. 4 illustrates discussions posted by users (screenshot).

FIG. 5 depicts an exemplary user profile (screenshot).

FIG. 6 shows an exemplary invitation engine (screenshot).

FIGS. 7A and 7B show an exemplary dashboard with an overview of discussions (screenshots).

FIG. 8 depicts an idea management interface where product researchers may view the status of ideas generated by users (screenshot).

FIGS. 9A and 9B illustrate exemplary embodiments showing how the current platform may be implemented into other sites (screenshots).

### DETAILED DESCRIPTION OF THE SPECIFIC EMBODIMENTS

Although described with particular reference to focus and research groups, those with skill in the arts will recognize that the disclosed embodiments have relevance to a wide variety of areas in addition to those specific examples described below.

All references, including publications, patent applications, and patents, cited herein are hereby incorporated by reference to the same extent as if each reference were individually and specifically indicated to be incorporated by reference and were set forth in its entirety herein.

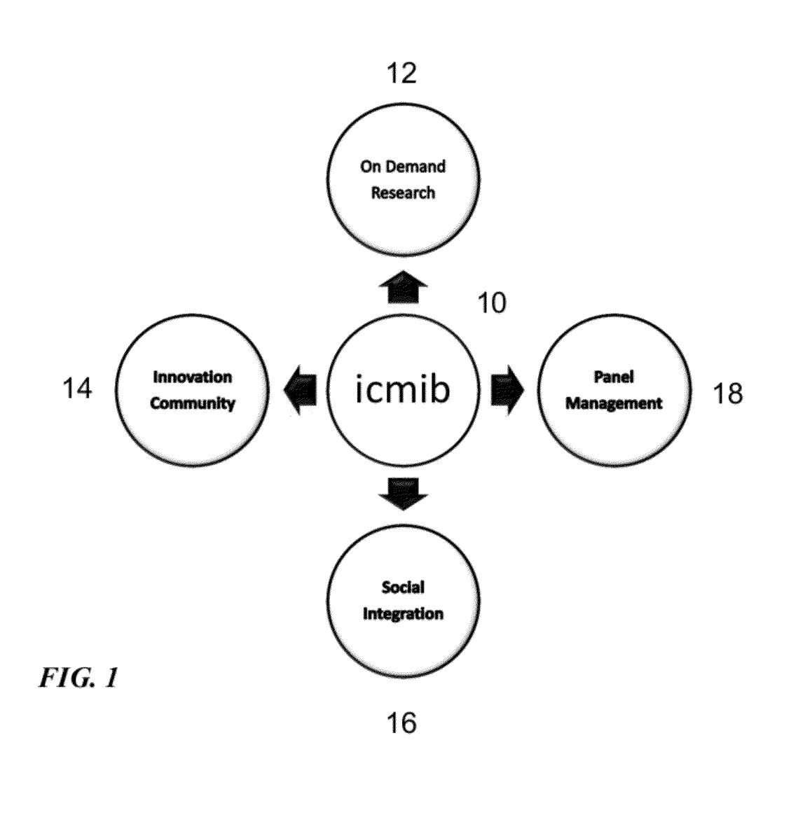

FIG. 1 illustrates the flow of ideas within the present disclosure's research platform. The platform 10 is a fully hosted, seamless community for market research providing on demand research tools 12 and an innovation community 14. It is also fully integratable into other social networks 16 to enable faster and smarter product innovation. The present disclosure merges the step of customer idea generation, through surveys or market sizing, to create product innovation with the step of research to validate that idea. This allows the direct tying of actionable product insights and improvements with the process of creating better products.

The present disclosure enables a novel method of connection with end-user customers through back-end panel management tools 18 and gives them a voice to share ideas that can be immediately acted upon to create better products. This helps organizations and communities listen to, understand and better service the needs of their customers and stakeholders. The entire process is enhanced and sped up through the use of social communities, and enables discussions, image sharing, testing, and ideation all within one platform.

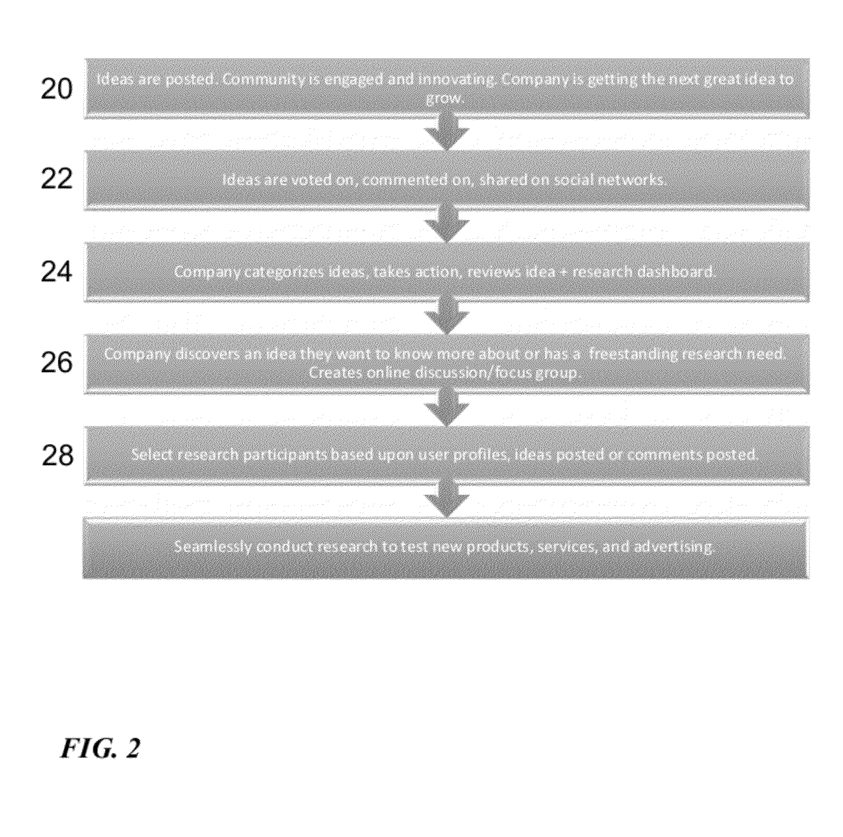

FIG. 2 displays a flow of how ideas flow to create research studies through the present disclosure's platform. Contributors and users 30 may quickly create or join discussions within minutes, skipping long processes of getting qualified by researchers before they are allowed to become a participant. First, community generated ideas 20 are used to engage the user base of the community. This leverages the power of the masses within various social networks to generate ideas, which may then become validated ideas 22 through the social networks via votes or comments.

The hosting product research administrator is empowered to view a detailed screening of a constantly updating pool of ideas created by the community's user base through the research dashboard 24. They may review and categorize these ideas, and then realize that they wish to learn more about a certain issue. They may also be reminded by the user comments of something else that has a freestanding research need. The present disclosure's platform enables the researcher to immediately recruit users, by engaging in profile-based selection, based upon their user profile, ideas, or comments to join more focused or private online discussion/focus groups 26. This process enables the researcher to select research participants that are more interested, knowledgeable about the subject matter than mere research participants recruited by a third party market research conductor. Real data and real results come from real people with real ideas, knowledge and passion, not “research participants.”

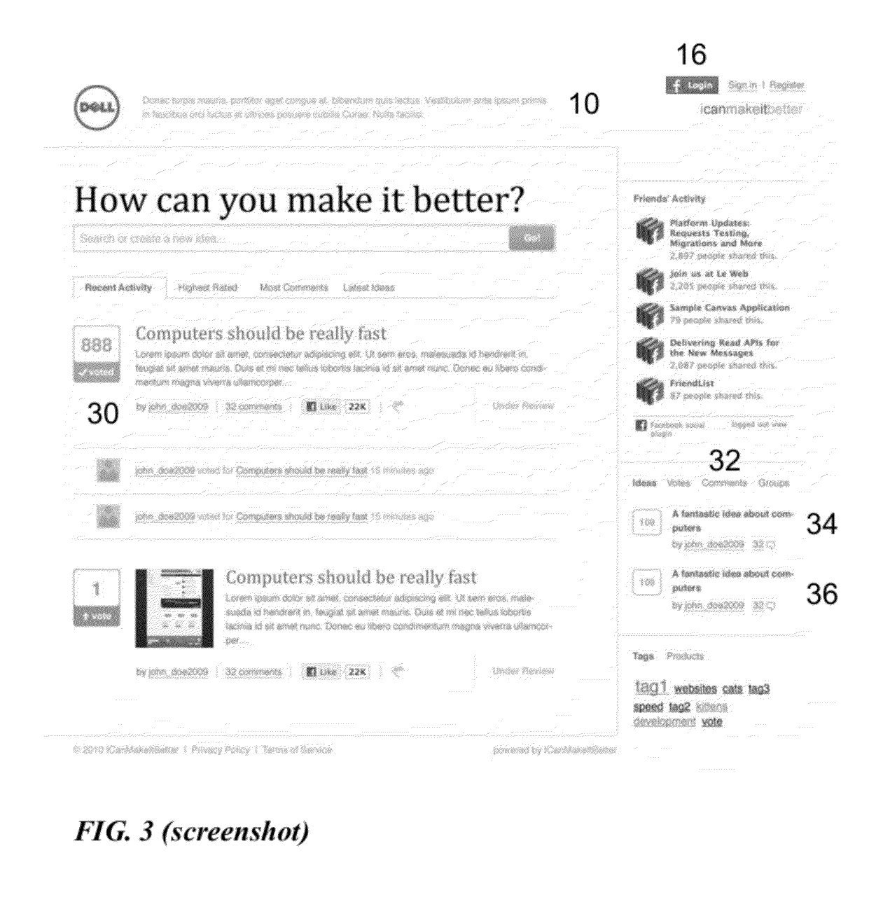

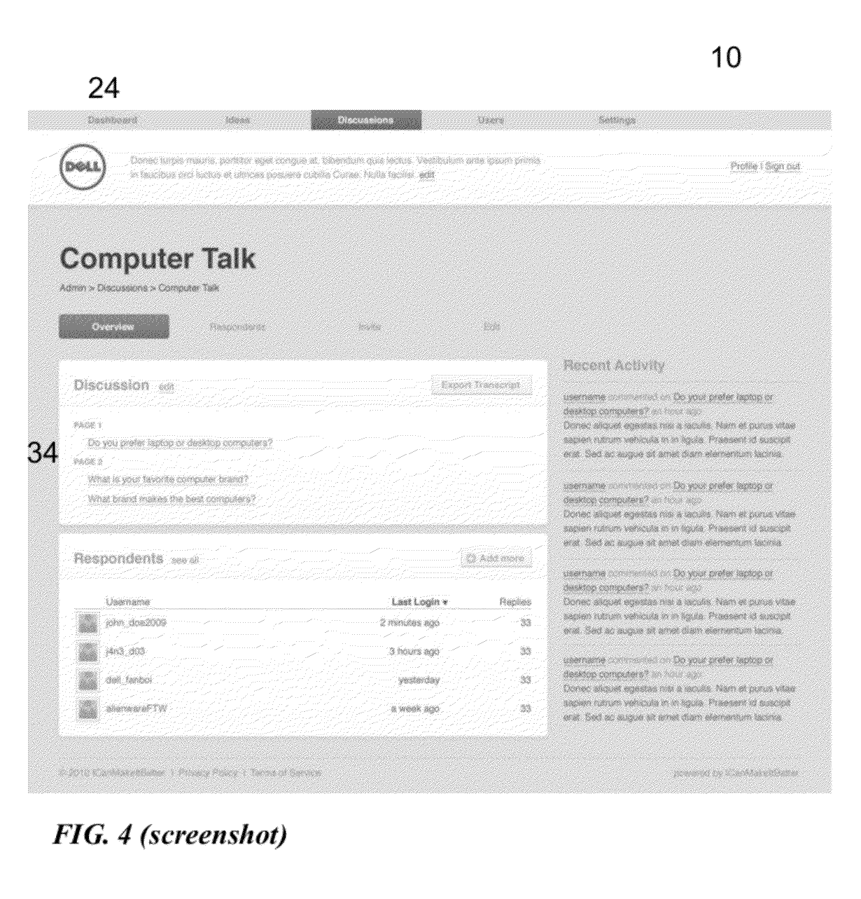

FIG. 3 portrays an exemplary embodiment of the present disclosure's research platform 10 in one application. This embodiment is applied towards one particular company, but may be implemented with any other subject matter and tailored for that particular application's uses. As previously discussed, the platform may be fully integrated with a social network 16 so any community generated ideas 20 may be immediately distributed to an entire network for idea generation. The user 30 is not constrained to predetermined topics and allows independent posting of comments 32, thereby avoiding groupthink or forcing the user to view issues from the company or researcher's perspective. The user 30 may also engage in previous discussions 34 and threads 36 created by other users. FIG. 4 illustrates discussions posted by users.

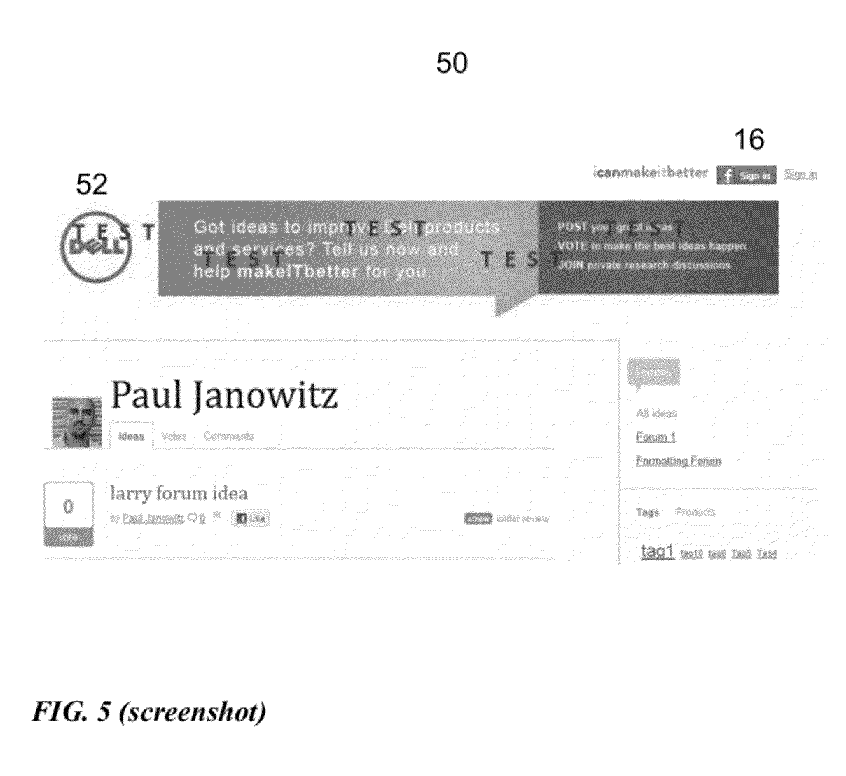

FIG. 5 depicts an exemplary user profile 50. Persistent user profiles with unique profile sections based upon end-user domains visited that are part of the research platform 10 includes multiple profile tabs with custom created questions by businesses 52 where a user is able to have a core profile and then domain specific profiles all tied to the same vetted user login. The research platform 10 provides a method for a single user ID, including 3^{rd} party login credentials, such as those from other social networks 16 that can then be propagated across multiple domains with different data/profile information associated with that user 30. For example, user PJ may create an account on the platform and fill out name, and job title. When they use company1platform.com and post an idea or comment on one they will be prompted to answer questions for that company (e.g., what products of company1 do you own). This user may then visit company2platform.com and this process will be repeated. Through this method and single user profile and sign-on is propagated across different domains, but each topic/domain will have its own unique attributes. The user 30 then uniquely has the ability to manage all of these profile attributes within a single login and user profile that persists across all hosted domains within the research platform 10.

Additionally, in one embodiment, the research platform 10 utilizes semantic analysis of user-generated content to trigger research actions. An online semantic engine takes unstructured data and triggers surveys, discussion invites, or other site actions based upon the content posted in ideas or comments, or votes by a given user. For example, if a user votes an idea up, they may receive an invitation to take a survey or participate in an online discussion for the product upon which that idea was associated. Another example would be similar use cases for posting positive vs. negative comments.

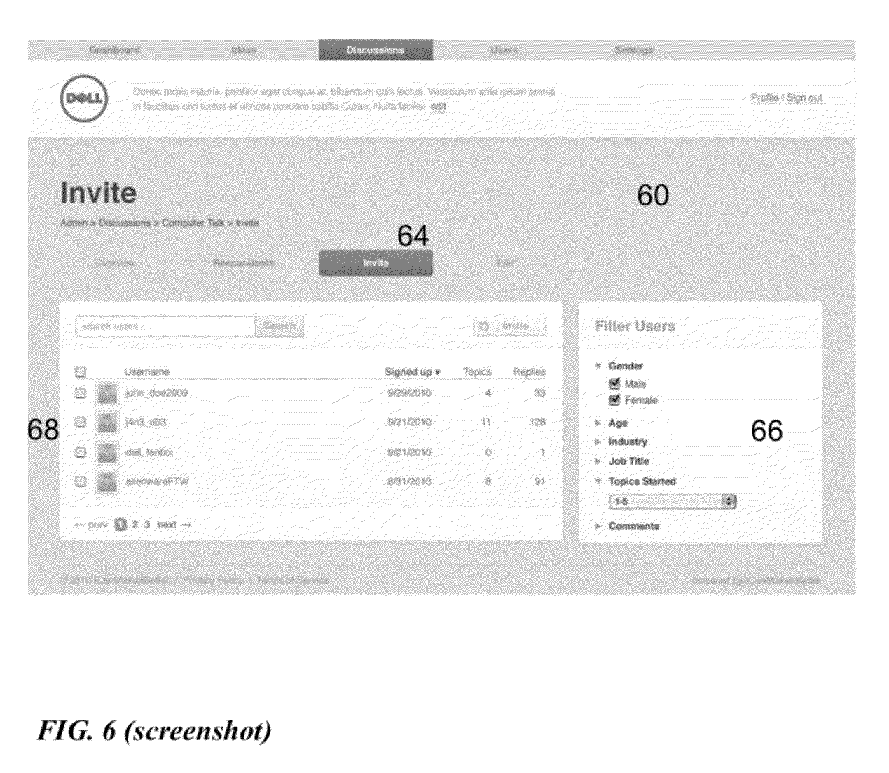

FIG. 6 shows an exemplary invitation engine 60 that enables direct invitations by the researcher to the user. The platform provides the machine and steps to transform community generated ideas 20 and associated activity, the user comments 32 and profile 50, into a market research online community (hereinafter, “MROC”) 62. This has been built as a standardized and simple process where, from any point within the research platform 10 a researcher can select users through direct invite or through a dynamic profile selection tool 64. The researcher can select variables and interactions 66 that the user 30 is associated with and the system will filter all users on that domain that meet the chosen criteria. Some exemplary variables and interactions 66 that may be employed within the current disclosure include, but is not limited to: demographics regarding gender, age, industry, job title, number of logins, number of posts, number of posts in a particular forum, membership in a particular forum, replies to other users, etc. The researcher can then select participants 68 for their MROC 62. With the direct invite, anyplace a user ID shows up, a researcher can select that user 30 to participate in an MROC 62. This selection method is pervasive across the research platform 10 and allows for researchers to screen and select research participants based upon actual site behavior, their ideas, comments 32, and user profile 50 instead of solely on a traditional screening survey.

The research platform 10 provides the method for taking unstructured community content and transforming that to selection criteria for market research including, but not limited to, quantitative surveys, qualitative online discussions, questions, sections, and moderation based upon end-user actions (idea posting, votes, comments, profiles). The platform enables the recruitment of users directly within idea discussions, profiles and predefined site actions. This creates unparalleled screening and recruitment insight. You get only truly interested, vetted and involved users.

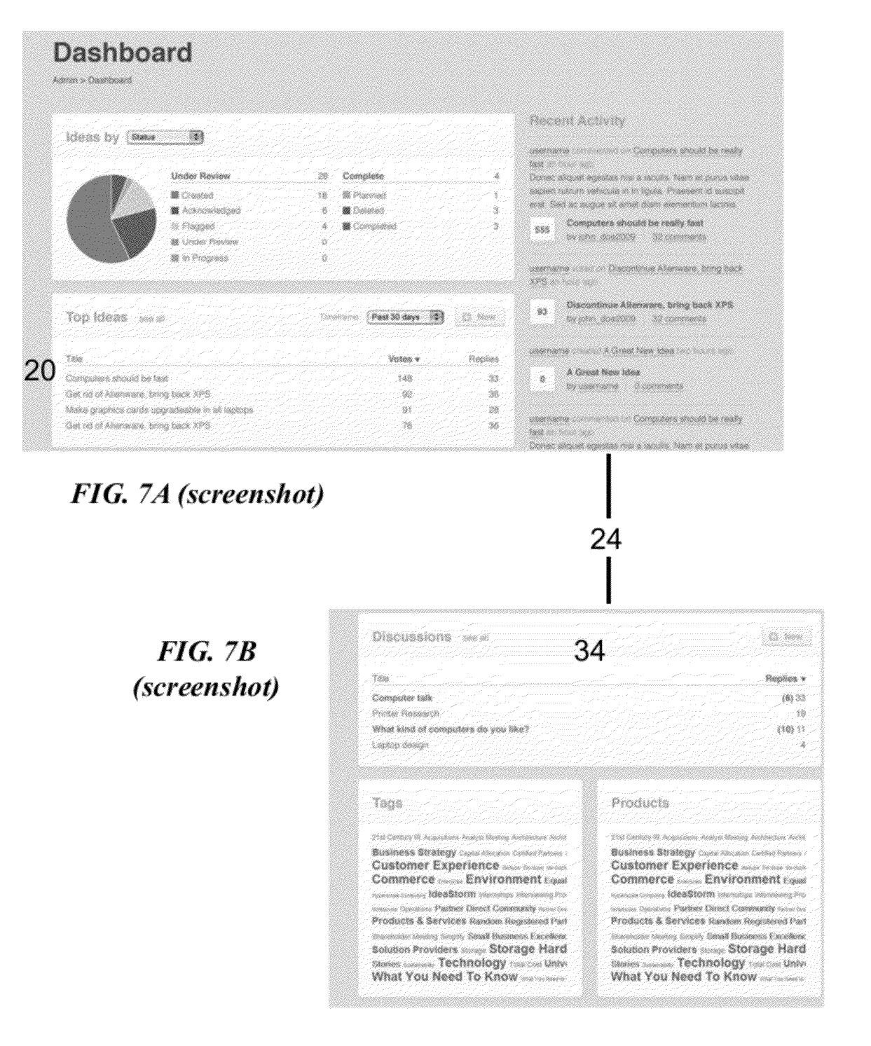

FIGS. 7A and 7B show exemplary research dashboards 24 with an overview of previous discussions 34. All of the community generated ideas 20 and previous discussions 34 regarding a product researcher's company may be viewed within the completely hosted solution within a web browser. This is secure and scalable to any size or complexity to meet the researcher's needs. There may only be one portal, to manage community innovation, users, and qualitative online market research, but this one portal enables full administrative control with customization.

The research dashboard 24 as illustrated in FIG. 7A and serves as a clear and easy-to-use base where ideas, comments 32, and research projects can be viewed and managed—all with live feeds of the latest activity. This enables an idea portal, researching, and panel management all within one platform system. FIG. 7B illustrates the second half of the dashboard page where the researcher may obtain a graphical representation of the most highly discussed topics, products, and mentioned tags.

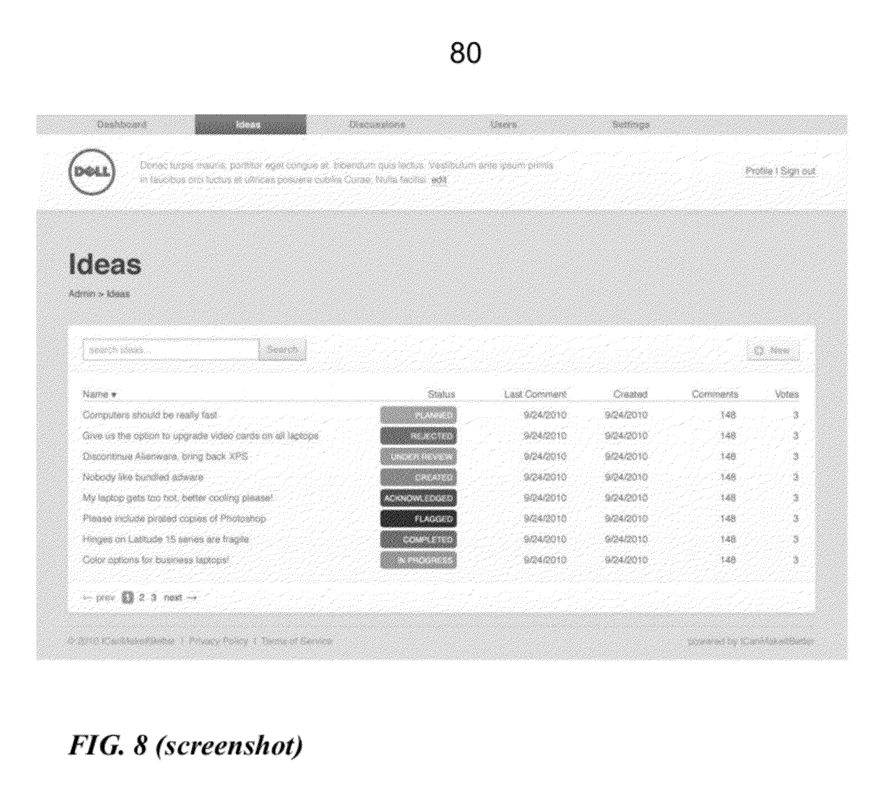

FIG. 8 depicts an idea management interface 80 where product researchers may view the status of community generated ideas 20 written by users 30. There is full sample management with the unique ability to select based upon ideas posted, comments 32, and detailed user profile 50 data.

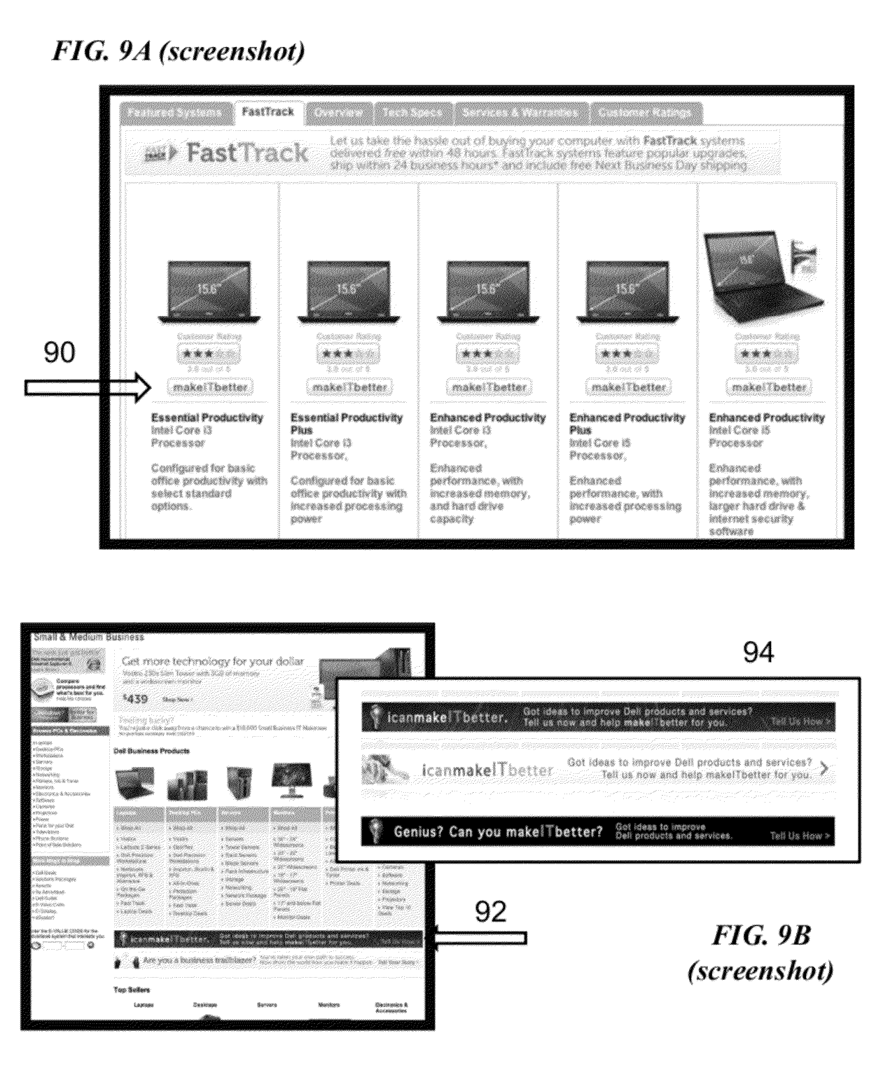

FIGS. 9A and 9B illustrate exemplary embodiments showing how the current research platform 10 may be implemented into other sites. The platform is fully implementable as a fully hostable Software as a Service (SaaS) solution 90. It may be customizable in various aspects, including, but not limited to: products, idea types, and logos, to be placed on a third party's website and may be combined with other media to generate ideas. When combined with full administrative controls for the third party to access generated ideas, it is possible for research costs and research times to be improved by multiple orders of magnitude.

FIG. 9A illustrates an exemplary embodiment of one type of implementation on a third party's laptop comparison and sale webpage. Here, at the time of shopping or decision making, if the customer wishes a laptop package had different specifications, they may be able to make an immediate comment through the research platform 10 directly from the third party website. The comment will reach the third party immediately. The alternative without the research platform 10 would most likely be a completely lost sale without any feedback as to why.

Another alternative without the platform described herein would be the customer buying the laptop, regretting the purchase, and not informing the third party of any errors or features that they would have enjoyed until it was too late to address the customer's concerns. If the platform had been implemented, it would have enabled the third party to respond to concerns earlier thereby increasing sales and/or potentially shave months off their product development timelines designing features and products that the customer wanted in the first place.

FIG. 9B illustrates another exemplary embodiment of an implementation on a third party's website whereby a button or banner 92 drives a call-to-action 94 and integrates with other research activities.

Additionally, the platform may be integrated with additional market research engagements, primary recruitment, social media, creative services and consulting as needed.

The foregoing description of the preferred embodiments is provided to enable any person skilled in the art to make or use the described subject matter. Various modifications to these embodiments will be readily apparent to those skilled in the art, and the generic principles defined herein may be applied to other embodiments. Thus, the claimed subject matter is not intended to be limited to the embodiments shown herein but is to be accorded the widest scope consistent with the principles and novel features disclosed herein.

The detailed description set forth above in connection with the appended drawings is intended as a description of exemplary embodiments in which the presently disclosed apparatus and system can be practiced. The term “exemplary” used throughout this description means “serving as an example, instance, or illustration,” and should not necessarily be construed as preferred or advantageous over other embodiments.

Further, although exemplary devices and schematics to implement the elements of the disclosed subject matter have been provided, one skilled in the art, using this disclosure, could develop additional hardware and/or software to practice the disclosed subject matter and each is intended to be included herein.

In addition to the above described embodiments, those skilled in the art will appreciate that this disclosure has application in a variety of arts and situations and this disclosure is intended to include the same.

What is claimed is:

1. A method for creating user generated research studies and ideas, comprising:
engaging an online community for soliciting of ideas, said online community and said ideas associated with a plurality of organizations, wherein said online community is made up of a plurality of contributors;
receiving community content associated with said organization, wherein said community content is comprised of a plurality of user generated comments, wherein said community content was generated at by said contributors through said online community;
sorting of said community content; and
presenting of community content to a researcher.

2. The method of claim 1, further comprising transforming of community content into selection criteria for market research.

3. The method of claim 1, wherein the sorting of community content is displayed on a research dashboard.

4. The method of claim 3, further comprising determining metrics associated with said community content.

5. The method of claim 1, further comprising creating of an online focus group or survey instrument.

6. The method of claim 4, further comprising selecting of research participants based upon user profiles.

7. A system for generating a user profile from user-generated content, comprising:
a set of computing devices implementing a plurality of domains hosted on the platform, each of said domains associated with an organization;
community content associated with each of said domains, said community content comprised of a plurality of user generated comments;
a research platform integrated with said plurality of domains, wherein said research platform aggregates said community content; and
a user profile for each user of the system.

8. The system of claim 7, wherein said user generated content further comprises triggers for inviting other users to participate in research studies.

9. The system of claim 7, further comprising a plurality of unique profile sections based on content generated.

10. The system of claim 7, further comprising a plurality of unique profile sections based on associated activity.

11. The system of claim 7, further comprising a plurality of unique profile sections based on end user domains.

12. A method for providing a messaging platform comprising:
detecting a mobile communications device within a geographic location, said mobile communications device associated with an unique location identifier;
transmitting said unique location identifier to said messaging platform;
receiving an unique location identifier of said mobile communications device; and
transmitting an invitation for action to said mobile communications device.

13. The method of claim 12, wherein said transmitting an invitation further comprises the step of triggering market research events.

14. The method of claim 13, wherein said market research events are related to the particular locale.

15. The method of claim 13, wherein said market research events are related to user activity upon said mobile communications device.

16. The method of claim 12, wherein said transmitting and receiving of said unique location identifier is via a server.

17. A method for engaging an online community, comprising:
discussing companies or individuals and said companies' or individuals' products or services, wherein said discussions include at least the posting of messages on said online community by a contributor;
storing said discussions on a non-transitory computer readable medium;
analyzing and storing said discussions and said contributor's demographics and populating a searchable database with traits, said traits including keywords from said discussions, said contributor's demographics, and other interactions between said contributor and said online community;
permitting a researcher access to said searchable database for the purpose of identifying traits of said contributor consistent with said researcher's goal.

18. The method of claim 17, further comprising accepting search parameters from said researcher, said search parameters having some subset of said traits.

19. The method of claim 17, further comprising returning a list of contributors matching said traits.
